(19) United States
(12) Patent Application Publication
(10) Pub. No.: US 2008/0250660 A1
(43) Pub. Date: Oct. 16, 2008

(54) Land surveying safety beacon

(76) Inventor: Jason Kyle Aydelotte, Lawrenceville, GA (US)

Correspondence Address: JASON AYDELOTTE, 111 CHANTILLY LANE, LAWRENCEVILLE, GA, 30043, US

(21) Appl. No.: 12/080,543

(22) Filed: Apr. 3, 2008

Related U.S. Application Data
(60) Provisional application No. 60/922,061, filed on Apr. 4, 2007.

(51) Int. Cl. G01C 15/06; G01D 21/00

(52) U.S. Cl. 33/293; 116/209

(57) ABSTRACT

A Land Surveying Safety Beacon that is secured above an existing land surveying prism assembly. The Land Surveying Safety Beacon includes a cylinder fitted with bright LED lights powered by a rechargeable battery and controlled by a switch on the top end. The bottom end of the Land Surveying Safety Beacon is threaded for securement to a standard male connection above the existing land surveying prism assembly. The fitting on the bottom end of the Land Surveying Safety Beacon is particularly formed to facilitate completed face-to-face contact and avoid misalignment when attached to an existing land surveying prism. The above abstract is neither intended to define the invention of the application, which is measured by the claims, nor is it intended to be limiting as to the scope of the invention in any way.

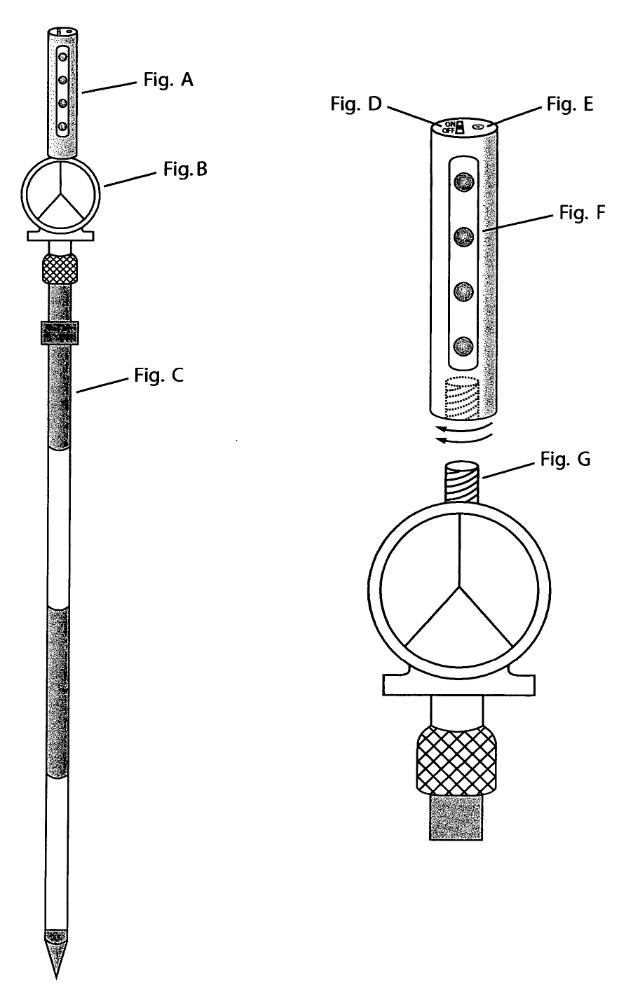

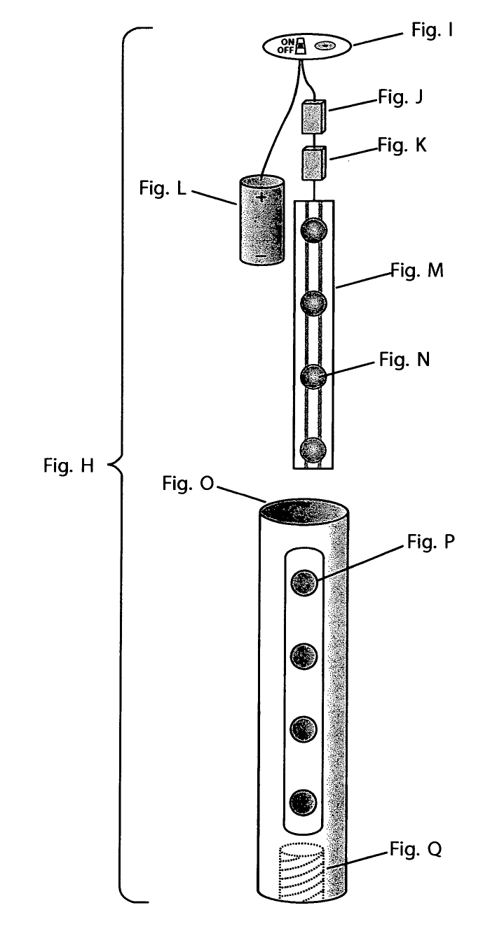

### CROSS REFERENCES TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING

Not Applicable

### BACKGROUND OF THE INVENTION

The present invention relates to Land Surveying Safety Beacon and particularly pertains to a device which is mounted atop an existing prism.

Land surveying and particularly the task of collecting field data requires that land surveyors enter and work in dangerous areas. Land surveying duties may include mapping roadway edges and centerlines which put land surveyors in close proximity of moving vehicles. A land surveyor is often employed on high density construction sites where heavy equipment like excavators, tractors, cranes, and dump trucks put the land surveyor in danger. These areas require certain safety precautions to insure the health and safety of land surveyors.

### BRIEF SUMMARY OF THE INVENTION

In view of the foregoing dangers inherent in the profession of land surveying, the present invention provides land surveyors added visibility and safety in traffic and construction situations. The Land Surveying Safety Beacon includes a hollow cylindrical housing which is enclosed with a top and female threaded bottom to connect to a standard ⅝″×11 male connection atop an existing land surveying prism. The cylinder wall is drilled in four vertical rows spaced at ninety degree increments that house bright LED lights for visibility in all directions. The lights are powered by a battery enclosed in the cylinder. A switch on the top of the Land Surveying Safety Beacon turns the lights on and off. The Land Surveying Safety Beacon is self contained and mounts on top of a standard prism assembly which is mounted on a standard surveying pole. When the Land Surveying Safety Beacon is turned on, a flashing beacon of light is produced. The light produced from the Land Surveying Safety Beacon would make the surveyor more visible to construction site traffic and roadway traffic, thus providing safety in dangerous environments.

It is therefore, the object of the Land Surveying Safety Beacon, to provide safety to land surveyors during the collection of data in the field.

It is another object of the Land Surveying Safety Beacon to be manufactured to be reliable and durable.

It is further an object of the Land Surveying Safety Beacon to be used with existing land surveying equipment.

It is another object of the Land Surveying Safety Beacon to use a quality rechargeable battery.

It is another object of the Land Surveying Safety Beacon to be manufactured so as the LED lights are bright and visible.

It is to be understood that the invention is not limited in its application to the details of construction and arrangement of components in the following description or illustrated in the drawings. The invention is capable of being practiced and carried out in various ways. It is also to be understood that the terminology used herein are for the purposes of description and should not be regarded as limiting.

### BRIEF DESCRIPTION OF THE SEVERAL VIEWS OF THE DRAWING

Fig. A is a perspective view of the Land Surveying Safety Beacon.

Fig. B is a perspective view of a standard land surveying prism assembly considered to be existing land surveying equipment.

Fig. C is a perspective view of a standard land surveying prism pole considered to be existing land surveying equipment.

Fig. D is a perspective view of a switch used to turn the Land Surveying Safety Beacon on and off.

Fig. E is a perspective view of a female D/C in connection for charging the battery.

Fig. F is a perspective view of one of four vertical rows of LED lights.

Fig. G is a perspective view of a standard ⅝″×11 male connection considered to be existing land

surveying equipment.

Fig. H is an exploded view of Land Surveying Safety Beacon Fig. A)

Fig. I is a perspective view of the end cap.

Fig. J is a perspective view of the regulator.

Fig. K is a perspective view of the flash timer.

Fig. L is a perspective view of the rechargeable battery.

Fig. M is a perspective view of the LED circuit board.

Fig. N is a perspective view of the LED lights.

Fig. O is a perspective view of the cylindrical housing.

Fig. P is a perspective view of the drilled holes that house the LED lights.

Fig. Q is a bottom end view of the ⅝″×11 female connection for securement to existing standard land surveying equipment.

### DETAILED DESCRIPTION OF THE INVENTION

Referring now to the drawings, and in particular Fig. A, a Land Surveying Safety Beacon. The Land Surveying Safety Beacon is constructed according to the principles of the present invention that is shown and will be described. The Land Surveying Safety Beacon is constructed from a 1″×4″ lightweight aluminum, hollow cylindrical housing (Fig. O). However, it is to be understood that the housing could be made of other lightweight material such as fiberglass or plastic, just as the dimension of the hollow cylindrical housing (Fig. O) could change without departing from the scope of the current invention. The housing (Fig. O) is painted at tenth of a foot increments (red and white) to show visual scale. However, it is understood that the housing (Fig. O) could be painted in a variety of ways and not depart from the scope of the present invention. The housing (Fig. O) is drilled at 90 degree increment around the housing in vertical rows (Fig. F). In the preferred embodiments, the number of light holes (Fig. P) in each 90 degree set equals four. However, the number of light holes (Fig. P) could increase or decrease without departing from the scope of the present invention. The bottom end (Fig. Q) is threaded for securement to a standard ⅝″×11 pitch male connection (Fig. G) considered to be existing land surveying equipment. In the preferred embodiment, the power source (Fig. L) is a rechargeable battery. However, it is understood that the power source could be any variety of battery without departing from the scope of the present invention. The power source (Fig. L) is positioned within the housing (Fig. O). The power source (Fig. L) is operatively coupled to the on/off switch (Fig. D) and voltage regulator (Fig. J). The voltage regulator (Fig. J) is positioned within the housing and regulates voltage from the power source (Fig. L) to the LED lights (Fig. N). The voltage regulator is operatively coupled to the flash timer (Fig. K). The flash timer (Fig. K) serves to flash the LED lights (Fig. N) simultaneously every one second. The flash timer is operatively coupled with the LED circuit boards (Fig. M) which house the LED lights (Fig. N). The components (Fig. J, Fig. K, Fig. L, Fig. M, Fig. N) are positioned securely within the housing (Fig. O) and the end cap (Fig. I) seals the housing to avoid damage to the components (Fig. J, Fig. K, Fig. L, Fig. M, Fig. N). The switch (Fig. D) and female connection D/C in (Fig. E) for charging are positioned on the end cap (Fig. I).

The Land Surveying Safety Beacon (Fig. A) is a land surveying device that is used primarily with a standard land surveying prism (Fig. B) and standard land surveying pole (Fig. C). A land surveyor using the Land Surveying Safety Beacon (Fig. A) with his or her existing equipment will appreciate the safety and security of being visible in all directions.

As various changes could be made in the above constructions without departing from the scope of the invention, it is intended that all matter contained in the above description or shown in the accompanying drawings shall be interpreted as illustrative and not in a limiting sense.

What I claim as my invention is:

1. A Land Surveying Safety Beacon constructed for mounting to a standard existing ⅝″×11 male connection atop a standard existing land surveying prism assembly.

2. A Land Surveying Safety Beacon constructed of a lightweight metal such as aluminum or light weight polymer.

3. A Land Surveying Safety Beacon which is constructed from a hollow cylinder in which holes are drilled in vertical rows and in 90 degree increments around the cylinder to house LED lights.

4. A Land Surveying Safety Beacon which is powered by a quality rechargeable battery and can be turned on and off.

5. A Land Surveying Safety Beacon that when turned on, LED lights flash brightly and are controlled by a flash timer.

6. A Land Surveying Safety Beacon designed to be used in conjunction with existing land surveying equipment.

7. A Land Surveying Safety Beacon that when turned on is visible in all directions to provide safety to the land surveyor while working in the field.

8. A Land Surveying Safety Beacon that is painted in tenth of a foot increments (red and white) to show visual scale.

9. A Land Surveying Safety Beacon that is sealed to prevent moisture from entering the housing.
